(19) United States
(12) Patent Application Publication
(10) Pub. No.: US 2026/0099982 A1
(43) Pub. Date: Apr. 9, 2026

(54) CAMOUFLAGE PATTERN EVALUATION SYSTEM

(71) Applicant: Crye Precision LLC, Brooklyn, NY (US)

(72) Inventors: Gregg THOMPSON, JR., Brooklyn, NY (US); Stefan RUBLOWSKY, Brooklyn, NY (US)

(21) Appl. No.: 19/348,509

(22) Filed: Oct. 2, 2025

Related U.S. Application Data
(60) Provisional application No. 63/703,020, filed on Oct. 3, 2024.

(51) Int. Cl. G06T 15/04; G06T 19/00

(52) U.S. Cl. CPC G06T 15/04; G06T 19/00

(57) ABSTRACT

Technologies for evaluating camouflage patterns disclosed herein provide a system that graphically renders one or more avatars within a 3D photorealistic virtual environment, in which a first camouflage pattern design is rendered over at least one of the avatars. The system generates a prompt for identifying a location of the avatar over which the first camouflage pattern design is rendered. One or more statistics associated with the identification is measured, and a score is generated based on the measurement.

### CROSS-REFERENCE TO RELATED APPLICATIONS

The present application claims the benefit of U.S. Provisional Patent Application No. 63/703,020, titled “CAMOUFLAGE PATTERN EVALUATION SYSTEM,” filed on Oct. 3, 2024, the entire disclosure of which is hereby incorporated by reference.

### TECHNICAL FIELD

The present disclosure generally relates to camouflage development, and more specifically, to a system for generating three-dimensional (3D) volumetric simulations and models for measuring the efficacy of a camouflage pattern design.

### BACKGROUND

Camouflage pattern design generally pertains to developing patterns and colors intended to conceal an individual or object from detection in the surrounding environment. Camouflage pattern design has many applications, particularly as in military uniforms used to enable military personnel to blend in with the immediate surroundings. Camouflage may also be deployed to obfuscate military equipment and installations from view.

Modern computing technology allows a designer to more easily develop camouflage patterns before incorporating them into physical samples or fabric. For instance, the designer may use graphic design software to formulate different colors and shapes to be applied in a camouflage pattern. In addition, some three-dimensional (3D) apparel design software tools even allow the designer to render a graphical avatar representing an individual wearing a virtual fabric incorporating a camouflage pattern with a very high level of realism.

In practice, the effectiveness of a camouflage pattern design is not readily ascertainable until a prototype has been produced and tested in a real-world environment in specific environmental conditions, which expends considerable resources. Another approach includes superimposing a camouflage design over a two-dimensional image of an environment, which provides only a loose approximation of how effective the design may be in a similar environment.

### SUMMARY

One embodiment presented herein discloses a method. The method generally includes graphically rendering, by execution of one or more processors, one or more avatars within a 3D photorealistic virtual environment. A first camouflage pattern design is rendered over at least one of the avatars. The method also includes generating a prompt for identifying a location of the at least one of the avatars having the first camouflage pattern design rendered. One or more statistics associated with the identification of the location of the avatars is measured, and a score is generated based on the measurement.

Another embodiment presented herein discloses a system having one or more processors and a memory storing instructions. The instructions, when executed on the one or more processors, causes the system to graphically render one or more avatars within a 3D photorealistic virtual environment. A first camouflage pattern design is rendered over at least one of the avatars. The system generates a prompt for identifying a location of the at least one of the avatars having the first camouflage pattern design rendered. One or more statistics associated with the identification of the location of the avatars is measured, and a score is generated based on the measurement.

Yet another embodiment presented herein discloses a computer-readable storage medium storing instructions. The instructions, when executed on the one or more processors, causes a system to graphically render one or more avatars within a 3D photorealistic virtual environment. A first camouflage pattern design is rendered over at least one of the avatars. The system generates a prompt for identifying a location of the at least one of the avatars having the first camouflage pattern design rendered. One or more statistics associated with the identification of the location of the avatars is measured, and a score is generated based on the measurement.

### BRIEF DESCRIPTION OF THE DRAWINGS

The foregoing aspects and other features of the disclosure are explained in the following description.

FIG. 1 is a block diagram illustrating an example computing environment for measuring an efficacy of a camouflage pattern design, according to an embodiment;

FIG. 2 is a block diagram illustrating an example computing system for measuring an efficacy of a camouflage pattern design, according to an embodiment;

FIG. 3 is a conceptual diagram of a software environment for the example computing system of FIG. 1, according to an embodiment;

FIG. 4 is a flow diagram of a method for evaluating a camouflage pattern design, according to an embodiment; and

FIGS. 5-9 are conceptual images depicting the camouflage pattern design techniques described herein, according to an embodiment.

### DETAILED DESCRIPTION

Currently, there is no commonly accepted technological protocol for measuring the efficacy of camouflage patterns. Modern approaches often use digital simulations or image analysis, but modeling real-world complexities (e.g., in lighting variations based on time of day, shadows, or seasonal changes; background textures and patterns; motion and perspective of the observer, etc.) is often difficult. Some techniques oversimplify environments, which results in designs that potentially perform well in simulations but fail in real-world conditions. Further, many current approaches are computationally intensive due to processing multivariable factors such as visual blending, pattern disruption, detectability at range, motion concealment, and so on. Modern systems that do not take one or more of such variables into account may result in a less accurate measurement of efficacy. Further still, non-digital efficacy measuring techniques have proven to be inadequate and costly, as such techniques require physical prototypes to be evaluated in a variety of physical locations (which can be difficult to access). Generally, evaluations towards efficacy should involve a statistical approach based on a large number of data points (e.g., based on visual environments and conditions that are identical, other than the patterns being evaluated).

To address these issues, embodiments presented herein disclose improvements in technologies for measuring the efficacy of a camouflage pattern design. More specifically, the present disclosure provides a software application used for developing, testing, and evaluating camouflage pattern designs. The software application may be used to create camouflage pattern designs (or import camouflage pattern designs from other software applications capable of apparel design creation) which can then be used to simulate the physical draping of a virtual garment printed in the camouflage design and having specified properties (e.g., a predefined number of pockets, specific stitching lines, etc.) to a three-dimensional (3D) graphical asset, for example an avatar representing a human individual, such that the avatar appears to be wearing the virtual garment. The software application may generate a photorealistic environment using a 3D computer graphics engine (such as a 3D graphics game engine) and render the environment as a scene on a display. Thereafter, the software application may graphically render the avatar wearing a virtual fabric incorporating the camouflage fabric within the scene. The avatar can be manipulated within the environment (e.g., placed in a given pose, positioned at a certain location within the environment, etc.). Once rendered on a display, a user may evaluate the camouflage design under the environmental conditions presented in the scene, such as lighting, atmospheric and climatic conditions, weather, and time of day. An evaluator user may then participate in statistically valid test protocols and scenarios that drive accurate evaluation results.

Embodiments also provide a system that measures the efficacy of a camouflage design based on the input of one or more users for use in manufacturing the camouflage design to a textile. The software application may generate a sequence of environmental scenes and render the avatar at a location within each scene. The scoring system may render a given scene on the display and prompt a user to locate the avatar within the scene. The scoring system may assign a score correlative to the effectiveness of the camouflage pattern design based on various parameters, such as the time taken to identify the avatar, biometrics (e.g., eye tracking using a connected camera device), an amount of misidentifications before the correct identification, user demographic information, and the like.

Advantageously, the techniques disclosed herein allow camouflage pattern designs constructed into virtual fabric, from which virtual garments are made, and then dressed onto 3D assets (e.g., avatars, vehicles, tents, tarp, edifices, etc.), to be evaluated in various environments and environmental conditions using 3D photorealistic virtual environments, which can significantly accelerate the camouflage development and testing process. Camouflage designs that exceed a threshold scoring can provide a reliable baseline in physically printing for use or further evaluation. Further, the system is capable of obtaining multiple data points (from multiple user inputs) and aggregate user scores to better identify effective designs. Further, in some embodiments, the scoring system may use machine learning and artificial intelligence (AI)-based techniques (e.g., using user inputs as training data for such models) to automatically assist in designing a camouflage pattern. Further still, in some embodiments, virtual reality or augmented reality devices (or other wearables or devices that provide spatial computing functionality) may be paired with the system to provide a more immersive user experience in identifying the camouflage pattern design in a given environment, such as by providing detection features available to the evaluator user, such as night vision capability, thermal and infrared detection, and so on. Further still, in some embodiments, the system may be coupled with fabrication or printing devices that can print designs from pattern design files to a fabric for use or additional evaluation.

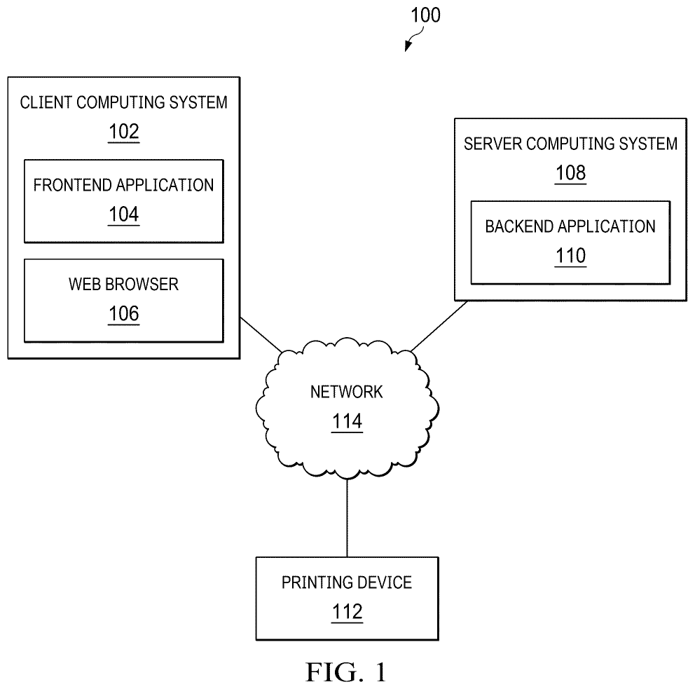

Referring now to FIG. 1, an example computing environment 100 for measuring the efficacy of camouflage pattern designs includes a client computing system 102, a server computing system 108, and a printing device 112, each interconnected via a network 114 (e.g., the Internet, a local area network, wide area network, private network, etc.).

The illustrative client computing system 102 and server computing system 108 can be any physical computer (e.g., a desktop computer, mobile device, laptop device, workstation, etc.) or virtual computing instance (e.g., executing on a cloud network) that is configured to design and evaluate camouflage pattern designs for characteristics such as efficacy in visually blending with a given environment. The client computing system 102 includes a frontend application 104 configured to communicate with a backend application 110 of the server computing system 108.

The frontend application 104 is a client-facing application that provides a user interface for the user to design and measure the efficacy of camouflage patterns for printing on a textile. The frontend application 104 may include various modules such as camouflage pattern design creation modules, design import modules (e.g., for importing designs from third-party software, such as V-Stitcher™), 3D computer graphics engines (e.g., Unreal Engine™ or other computer game graphics engines, etc.), scoring modules. Various users may access the frontend application 104, such as an evaluator user indicative of an individual participating in an evaluation session, a test architect user indicative of an individual establishing parameters and other configurations for an evaluation session, a test administrator user indicative of an individual overseeing evaluator users participating in an evaluation session, etc. As further described herein, the frontend application 104 enables the test architect user to generate three-dimensional (3D) simulations that graphically render camouflage pattern designs on fabrics in photorealistic environmental scenes to a graphical user interface (GUI). The frontend application 104 also provides features for evaluator users to view the scenes and try to locate the camouflage patterns within the scene. The frontend application 104 may be configured with one or more different types of scoring methods (as further described herein) that are based on the ability of the evaluator user to identify the presence of digital avatars in a scene on which a garment having a designed camouflage pattern is rendered.

The backend application 110 performs management and storage functions such as managing user profiles and designs, design storage, evaluation records, test parameters, graphical assets (e.g., environmental models used to generate scenes, digital avatars, and the like). The backend application 110 may expose a GUI via a web server application programming interface (API) that can be accessed by the frontend application 104 or via a web browser 106. The GUI provided by the backend application 110 may provide, for example, user management, testing environment, and storage management functions.

The printing device 112 is a device used to apply camouflage pattern designs to a physical textile using some printing process. Examples of printing devices 112 can include rotary screen printers, flatbed screen printing devices, digital textile inkjet printers, dye-sublimination or heat transfer printers, direct-to-garment printers, and the like. In some embodiments, the printing device 112 may be interconnected with the client computing system 102 and server computing system 108 via the network 114 to receive designs and commands from the either system 102, 108 to cause the printing device 112 to print the designs to the textile.

Note, although FIG. 1 depicts a single client computing system 102, server computing system 108, printing device 112, and network 114, one of skill in the art will recognize that in practice, multiple systems 102, 108, printing devices 112, and networks 114 may be used to carry out the functions of the embodiments disclosed herein. Further, although FIG. 1 depicts a client-server architecture for carrying out such functions, one of skill in the art will recognize that other types of software architectures may be adapted, such as microservice architectures, distributed architectures, etc. Further, the client computing system 102 may be adapted to perform some or all of the tasks managed by the server computing system 108, such as user management and data storage. Further still, the server computing system 108 may be adapted to perform some or all of the tasks of the server computing system 108, such as rendering three-dimensional scenes and graphical assets for presentation on a user-facing display, scoring user identifications of avatars within a scene, and so on.

As used herein, a digital avatar is defined as any computer-generated graphical representation of an entity, such as a human, animal, machine, abstract shape, building, and the like, which is rendered on a display device (e.g., on a display of the client computing system 102 and/or the server computing system 108). In some embodiments, the avatar is defined by a data model that includes a geometric mesh or other structural framework and one or more texture maps applied to the framework to visually depict surface features such as skin tone, clothing, or environmental wear. The rendering of the digital avatar may include real-time shading, lighting, and animation based on user inputs, pre-scripted instructions, or sensor-derived signals.

As used herein, a camouflage pattern design refers to any computer-generated or physically produced arrangement of shapes, colors, textures, and/or gradients configured to visually disrupt, obscure, or blend the outline of an object with a surrounding environment. A camouflage pattern design may include irregular or repeating graphical elements applied in one or more layers and can be represented as digital image data, vector graphics, or procedural generation parameters. The camouflage pattern design may be configured for rendering on a display (e.g., a display of the client computing system 102 and/or the server computing system 108) to visualize its appearance, and may be further output for physical application to a substrate such as a fabric, polymer, metal, or composite material.

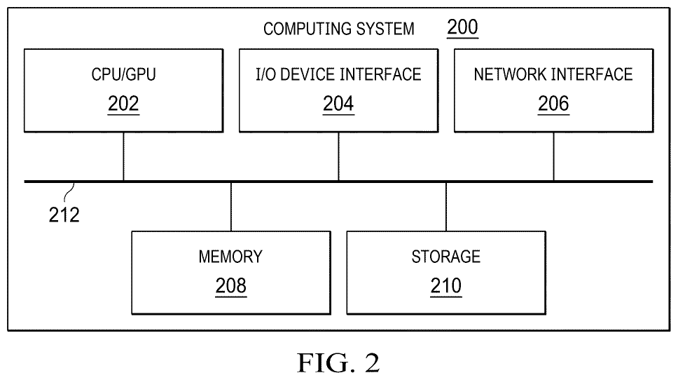

Referring now to FIG. 2, a block diagram of an example computing system 200 configured to design and evaluate camouflage pattern designs for characteristics such as efficacy in visually blending with a given environment is now shown. Illustratively, the computing system 200 includes, without limitation, a central processing unit (CPU)/graphics processing unit (GPU) 202, an I/O device interface 204, a network interface 206, a memory 210, and a storage 212, each interconnected via a hardware bus 208. Of course, the actual computing system 200 will include a variety of additional hardware (or software-based) components not shown. Additionally, in some embodiments, one or more of the illustrative components may be incorporated in, or otherwise form a portion of, another component. The computing system 200 may represent, for example, the client computing system 102 and/or the server computing system 108.

The CPU/GPU 202 retrieves and executes programming instructions stored in the memory 210. The CPU/GPU 202 may be embodied as one or more processors, each processor being a type capable of performing the functions described herein. For example, the CPU/GPU 202 may be embodied as a single or multi-core processor(s), a graphics processor, a microcontroller, or other processor or processing/controlling circuit. In some embodiments, the CPU/GPU 202 may be embodied as, include, or be coupled to a field programmable gate array (FPGA), an application-specific integrated circuit (ASIC), reconfigurable hardware or hardware circuitry, or other specialized hardware to facilitate performance of the functions described herein. The hardware bus 208 is used to transmit instructions and data between the CPU/GPU 202, storage 212, network interface 206, and the memory 210. CPU/GPU 202 is included to be representative of a single CPU, multiple CPUs, a single CPU having multiple processing cores, a graphics processor, and the like. The memory 210 may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

The network interface 206 may be embodied as any hardware, software, or circuitry (e.g., a network interface card) used to connect the computing system 200 over a network (e.g., the Internet) and providing the network communication component functions, such as accepting connections from other computing devices (e.g., remote client devices participating in the camouflage pattern design evaluation process), importing camouflage pattern design data and graphical asset data from networked devices, and so on. The network interface 206 may be embodied as any communication circuit, device, or collection thereof, capable of enabling communications over the network between the computing system 200 and other devices. The network interface 206 may be configured to use any one or more communication technology (e.g., wired, wireless, and/or cellular communications) and associated protocols (e.g., Ethernet, Bluetooth®, Wi-Fi®, WiMAX, 5G-based protocols, etc.) to effect such communication. For example, to do so, the network interface 206 may include a network interface controller (NIC, not shown), embodied as one or more add-in-boards, daughtercards, controller chips, chipsets, or other devices that may be used by the computing system 200 for network communications with remote devices. For example, the NIC may be embodied as an expansion card coupled to the I/O device interface 206 over an expansion bus such as PCI Express.

The I/O device interface 204 allows I/O devices to communicate with hardware and software components of the computing system 200. For example, the I/O device interface 204 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O device interface 204 may form a portion of a system-on-a-chip (SoC) and be incorporated, along with one or more of the CPU/GPU 102, the memory 210, and other components of the computing system 200. The I/O devices (not shown) may be embodied as any type of I/O device connected with or provided as a component to the computing system 200, such as keyboards, mice, and printers. In addition, the I/O devices may include audio and video sensors (e.g., a camera, camera having an audio input functionality, microphone), biometric sensors, and the like, that may be used to capture user activity.

The storage 212 may be embodied as any type of device configured for short-term or long-term storage of data such as, for example, memory devices and circuits, memory cards, hard disk drives (HDDs), solid-state drives (SSDs), or other data storage devices. The storage 212 may include a system partition that stores data and firmware code for the storage 212. The storage 212 may also include an operating system partition that stores data files and executables for an operating system.

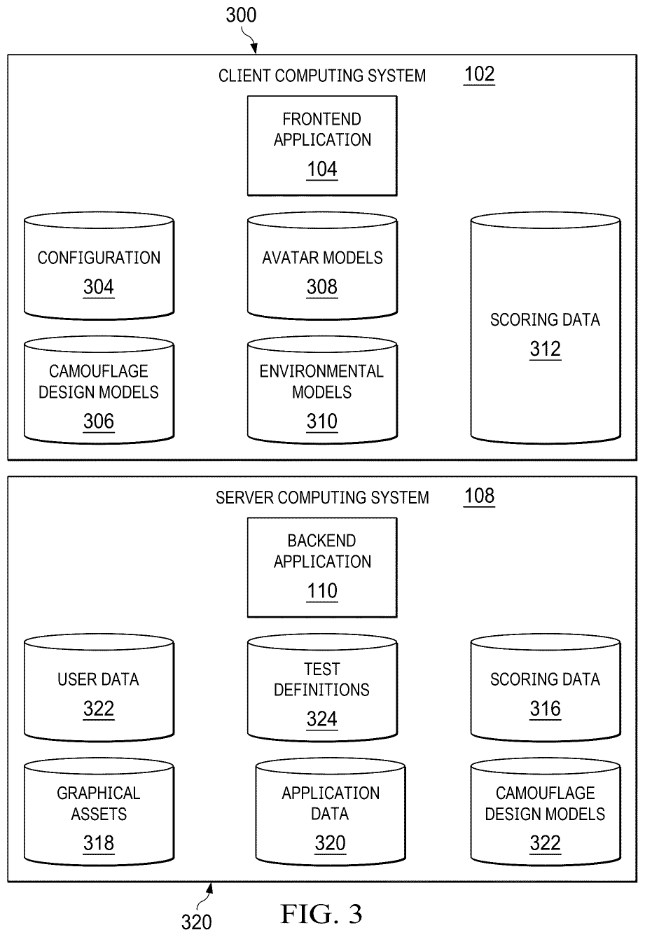

Referring now to FIG. 3, the client computing system 102 may establish an operational environment 300 that includes the frontend application 104, which is representative of the client-side interface for the camouflage pattern design and testing software tool. The application 104 may be stored as instructions in the memory 110, which, when executed by the CPU/GPU 102, perform the functions described herein.

The environment 300 also includes local instances of data used by the application 104 in operation. For example, the environment 300 includes configuration 304 (e.g., test configuration data, program settings, environment settings, camera settings, settings for atmospheric and climatic conditions, evaluator augmentation settings (e.g., whether a detection setting is enabled such as for night vision, thermal detection, infrared detection, etc.), lighting settings, avatar placement configurations, specification of camouflage types to compare, amount of environmental scenes to cycle through per evaluation session, randomization, etc.), camouflage design models 306 (3D graphical assets representative of a camouflage pattern design and associated fabrics), avatar models 308 (3D graphical assets representative of an individual person or object such as military equipment, installations, vehicles, tarps, flat panels, etc.), environmental models 310 (3D graphical assets representative of various types of environments, such as dry environments having varied vegetation and moderate elevation, temperate forest environments, alpine terrains, urban environments, and so on), and scoring data 312 (scoring information generated for evaluator users correlated to respective camouflage design models 306). These local components may be maintained within the storage 112 and later retrieved. For example, the scoring data may be exported to other applications (e.g., third-party applications) for further analysis. In an embodiment, the local components may be transmitted to the server computing system 108 for storage by the server computing system 108.

Illustratively, the server computing system 108 may establish an operational environment 320 that includes the backend application 110 and stored data that may be accessed by the client computing system 102, such as user data 322, test definitions 324, scoring data 316, graphical assets 318, application data 320, and camouflage design models 322.

The user data 322 may be embodied as data that can include user identification and account data (e.g., usernames, passwords, authentication tokens), role assignment (e.g., administrator, designer, evaluator, etc.), activity data (e.g., records of user interactions with various scenes, logs, other communications), associated camouflage pattern designs, and the like.

Test definitions 324 may be embodied as data parameters used to direct an evaluation session and scoring mechanisms associated with the system. For example, a test definition may be embodied as a file that includes, for example, selections of two or more camouflage patterns to be compared, one or more scenes to be presented, atmospheric presets to associate with the scene (e.g., environmental conditions for time of day, weather, clouds, wind, haze, etc.), camera locations (e.g., focal length, pan rate, etc.), avatar poses, a number of avatars per scene (which the scoring mechanisms of the frontend application 104 and backend application 110 may use as data points), avatar skin tone, avatar placement settings (e.g., all avatars appear in the scene, only one pair of avatars appears in the scene, one avatar disappears after another avatar is selected, randomized appearances, placement distances between avatars, sequential placement, etc.), evaluation mode (e.g., fixed mode in which the camera is in a specific location and in which keyboard commands limit the user to pan within the scene, free mode in which keyboard commands allow the camera to move freely in three dimensions within the scene, design mode in which keyboard commands allow the user to toggle between selected camouflage patterns to be applied to the avatars within the scene), fabric rendering options, and so on.

Scoring data 316 may be embodied as any data that includes scoring mechanisms and scoring records associated with camouflage pattern design evaluation. For example, the scoring mechanisms may be defined by a test definition 324, camera (e.g., scoring based on evaluation conducted using a fixed camera, scoring based on evaluation conducted using a free camera, etc.), and so on. Scoring records may be associated with aspects of an evaluation session, such as scoring by user, by scene, by camouflage pattern design, by environment, and the like.

Graphical assets 318 may be embodied as any data that define or represent the rendering of three-dimensional visual content for the frontend application 104. A graphical asset 318 may include any digital representation of a shape, surface, texture, or animation for use in simulated environments used to evaluate camouflage pattern designs. For example, the graphical assets 318 may include avatar models (e.g., global assets for the avatar models 308), environmental models (e.g., global assets for the environmental models 310), and the like.

Application data 320 may be embodied as any data associated with the operation frontend application 104 and the backend application 110, such as color calibration configurations (e.g., tone mapping settings, monitor size and resolution, color properties), evaluation settings, network and storage configurations, and so on.

Camouflage design models 322 may be embodied as any data associated with camouflage pattern designs used for evaluation. For example, the server computing system 108 may serve as a repository for user-created camouflage design models 322, which can be loaded onto the client computing system 102 (e.g., as local camouflage design models 306).

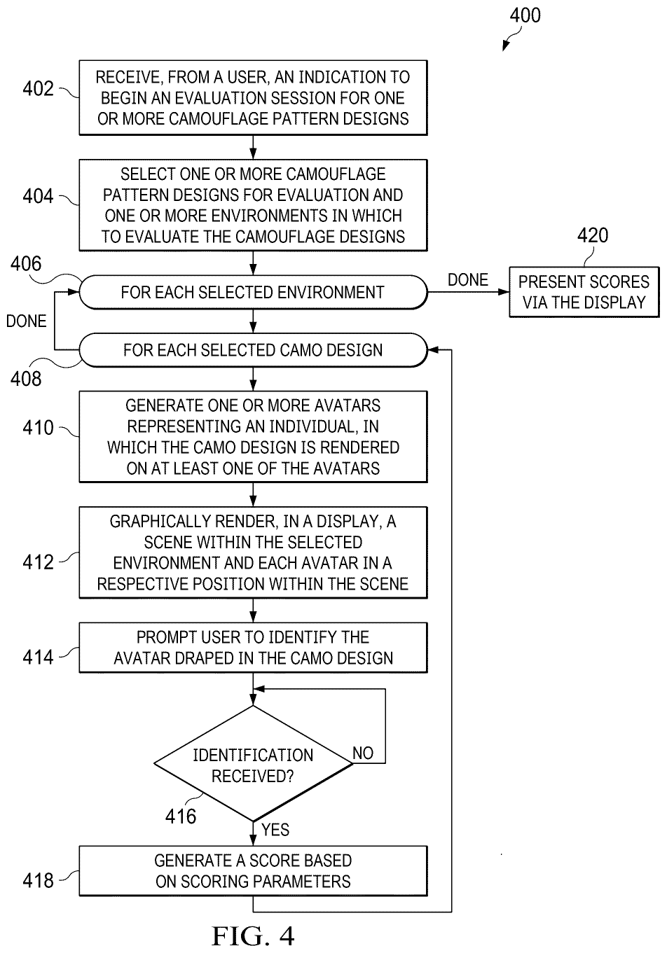

Referring now to FIG. 4, the computing system 102, in operation (e.g., via the frontend application 104), performs an example method 400 for measuring the efficacy of camouflage pattern design. In this example, assume that the frontend application 104 has been initialized. During initialization, the frontend application 104 may submit user credentials to the backend application 110 and sync data (e.g., test definition information, graphical assets, camouflage designs, application data, and the like) over a network connection. Note, although the following describes the method 400 steps as being performed solely by the frontend application 104, one of skill in the art will recognize that one or more steps of the method 400 can be carried out by other processes, such as the backend application 110.

As shown, the method 400 begins in block 402, in which the frontend application 104 receives, from an evaluator user (e.g., an individual participating in the evaluation session), an indication to begin an evaluation session for one or more camouflage pattern designs. For example, the user may click on an icon of a GUI provided by the application 104 to initiate the evaluation session. In other embodiments, the user may access the GUI (e.g., exposed by the backend application 110) via a client device to conduct the evaluation (e.g., via a web browser or application that is provided access to the frontend application 104 or backend application 110).

In block 404, the application 104 selects one or more camouflage pattern designs for evaluation and one or more environments in which to evaluate the camouflage designs. The selection may be user generated (e.g., via the GUI of the application 104 at the time of initiating the evaluation) or predefined. In other embodiments, the selection may be randomized, e.g., from a small subset of camouflage pattern designs.

In block 406, the application 104 enters a loop for each selected environment, with a nested loop for each selected camouflage design in block 408. In block 410, the application 104 generates one or more avatars representing an individual, in which one of the avatars is rendered to wear a fabric incorporating the camouflage pattern design. In block 412, the application 104 renders a scene within the environment, placing each avatar in a given position within the scene. The placement of avatars may be predefined, randomly determined, or determined based on specified criteria (e.g., lighting, in a specific pose, in proximity of objects such as cars, buildings, fences, trees, etc.), or some combination. In addition, the selected scenes may be subject to certain conditions, such as lighting, time of day, an amount of other foreground objects in the scene, and so on. In block 414, the application 104 may prompt the user to identify the avatar that is dressed in the fabric incorporating the camouflage pattern design. In some embodiments, instead of (or in addition to) an avatar representing a human individual, the application 104 may generate an avatar or other 3D graphical asset representing another object for evaluation, such as animals, vehicles, tents, buildings, tarps, flat panels, etc.

In an embodiment, the application 104 optionally activates a timer that runs while the user is locating the avatar. In an embodiment, the timer is a countdown timer having a specified value (though one of skill in the art will recognize that the timer may also simply measure the amount of time during the evaluation session or during a segment of the evaluation session). The timer may also be configured not to limit the amount of time that the user has to locate the avatar but to measure the amount of time that the user takes to do so. In block 416, the application 104 determines whether a positive identification has been received (e.g., whether a user click on a given avatar corresponds to the correct one). If so, then in block 418, the application 104 generates a score based on one or more scoring parameters. In some embodiments, the score may also be based relative to a comparison between more than one camouflage designs (e.g., an indication by the user of which of the camouflage designs was more difficult to locate, in which the indication is provided as feedback by the user or based on other metrics such as how quickly the user was able to locate one over the other). The method 400 then continues to iterate through the loops of 406 and 408 until the camouflage designs are evaluated in each selected environment. In block 420, the application 104 may present the generated scores via the display. The application 104 may also store scoring data (e.g., for further analytics) in the storage 112.

In an embodiment, the frontend application 104 may determine whether the score generated from block 418 exceeds a specified threshold. The specified threshold may be an indicator that the camouflage pattern design is suitable for use or further evaluation in a physical setting. In such a case, if the score exceeds a specified threshold, the frontend application 104 may transmit instructions to the printing device 112 to cause the printing device 112 to print the camouflage pattern design, e.g., to a swatch or a textile fabric.

Note, the method 400 presents only an example of how the evaluation process may operate. One of skill in the art will recognize that other approaches may be adapted to measure the efficacy of a camouflage pattern design. For example, the instructions provided to an evaluator user may differ from that disclosed above. In some configurations, all generated avatars may be outfitted in the selected camouflage pattern design, and the user would be instructed to locate each avatar within an allotted time limit.

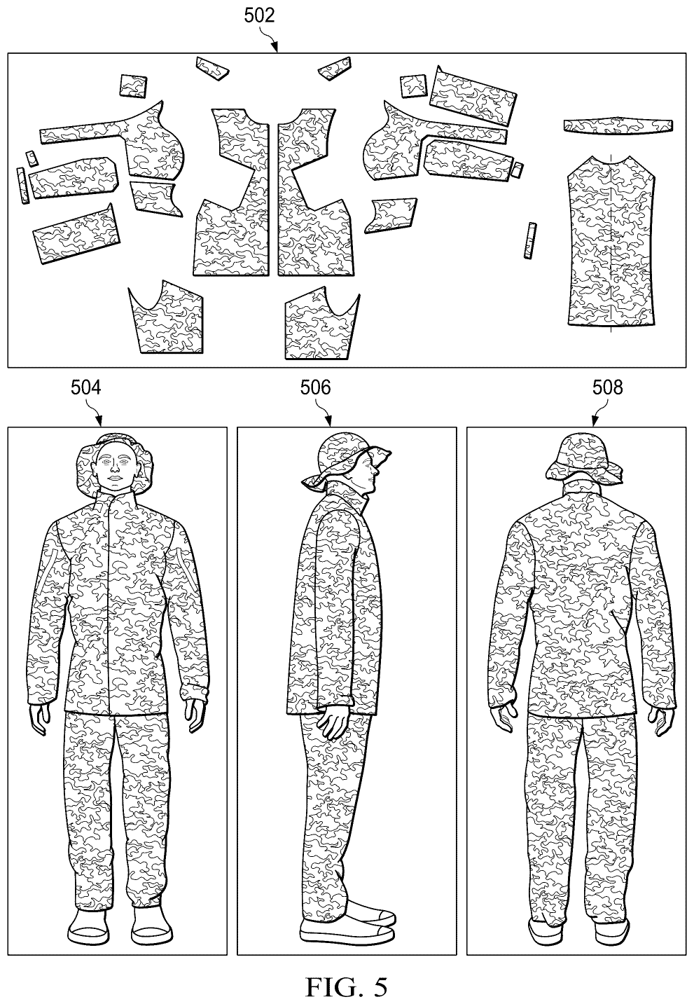

FIGS. 5-9 depict example screenshots of the evaluation system of the present disclosure. FIG. 5 depicts an example of applying a given camouflage pattern over an apparel design and thereafter rendering an avatar wearing the apparel design. FIG. 5 includes a pattern layout 502 for a garment fabrication with a camouflage texture mapped onto individual fabric pieces. More specifically, the pattern layout 502 is a digital representation of garment pattern pieces, each defined by a two-dimensional fabric shape in which the pattern pieces is overlaid with a predefined camouflage pattern. FIG. 5 also depicts computer-generated visualizations 504 (front view), 506 (side view), 508 (rear view) of a digital avatar wearing a garment that is fabricated using the pattern pieces and predefined camouflage pattern.

Advantageously, the computing system 102 is able to accurately construct a garment based on user specifications, such as in a given trim, number of pockets, specified lengths, etc. Doing so allows a user to observe how the camouflage pattern is applied to the fabric and adjust the pattern or cut accordingly. In an embodiment, the computing system 102 may render and display the garment based on the user specifications to allow a user to better evaluate the effectiveness of the garment independent of the camouflage design.

In an embodiment, a set of posed avatars may be pregenerated. The avatars may have realistic features for authenticity. Appropriate clothing item patterns can be imported and simulated to be draped on the avatars. These can include uniform tops and bottoms, gloves, balaclava, and so on. A camouflage pattern file may be applied to the draped avatars including any applied fabric textures (e.g., ripstop, cotton twill, etc.). The mapping of the pattern file to pattern pieces (e.g., as shown in the pattern layout 502) may be defined such that the pieces are spread out across the camouflage pattern file (and not all from one area). Clothing accessories can also be added to the avatar, such as boots, helmets, and other gear. In an embodiment, the frontend application 104 may verify fabric mappings, texture map normal, and texture map scaling to ensure accuracy and authenticity of the pattern on the visualized garment.

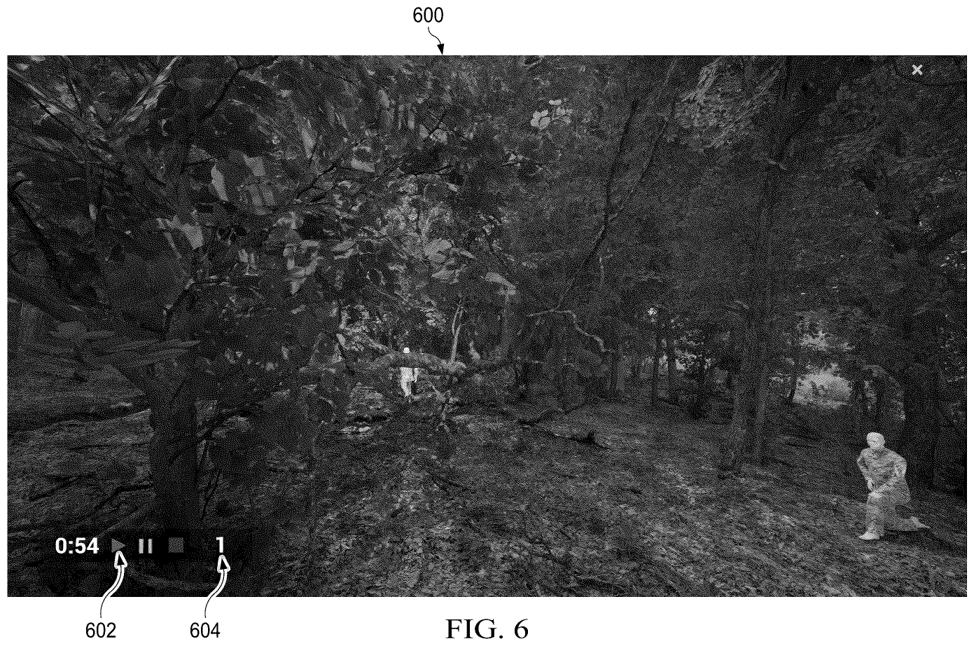

FIG. 6 depicts example digital avatars being placed in various positions within a forest environment scene 600 that is graphically rendered and displayed on a user interface for an evaluator user to locate the avatars therewithin. In this example, the avatars are shown with highlighting (though the application may be configured to not highlight the avatar when rendered and displayed), in which one avatar is located towards the center of the scene 600 and another avatar is located towards the bottom right portion of the screen. Each avatar is digitally draped in predefined camouflage patterns. Also in this example, the user interface provides a timer and controls 602 and a counter 604 indicative of a number of avatars identified by the user.

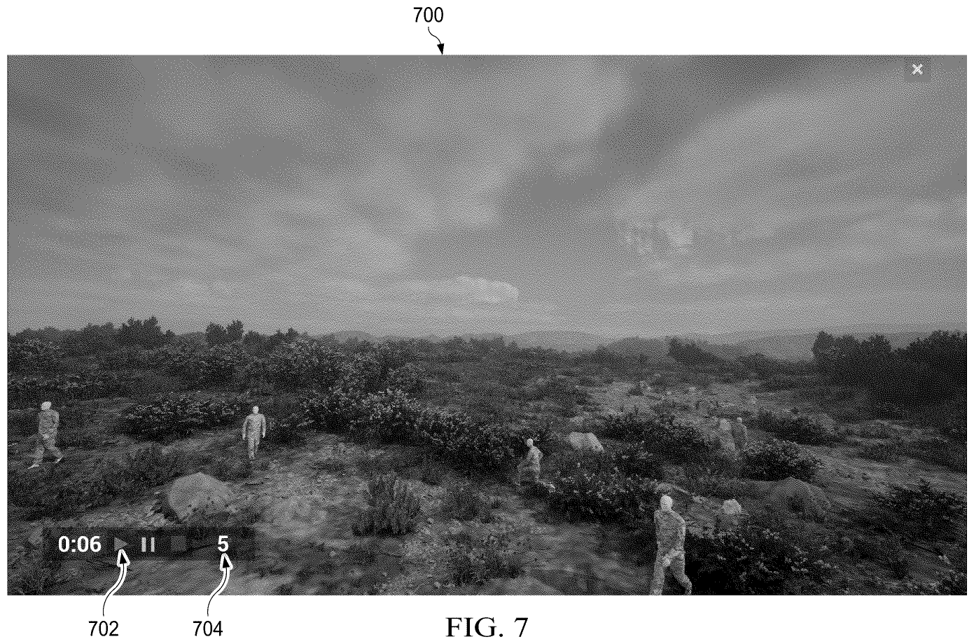

FIG. 7 depicts example digital avatars being placed in various positions within a dryland environment scene 700 with sparse vegetation that is graphically rendered and displayed on a user interface. Similar to FIG. 6, the user interface provides a timer and controls 702 and a counter 704 indicating a number of avatars in the scene 700 identified by the user. Of course, it should be clear to one of skill in the art that the actual implementation of the evaluation session in the software may include additional features or omit some of the aforementioned features such as the timer, without taking away from the broader inventive concept of evaluating the efficacy of a camouflage pattern design (or pattern design generally) based on real-time user observations of the design. The user may identify the avatars within the scene, e.g., by hovering a mouse cursor (not shown) to over the avatar and clicking thereon. In some embodiments, a touch screen may be used in which the user taps the avatar on the screen (e.g., with their finger or a stylus). In response to detection, the counter is incremented, and scores based on time may be recorded.

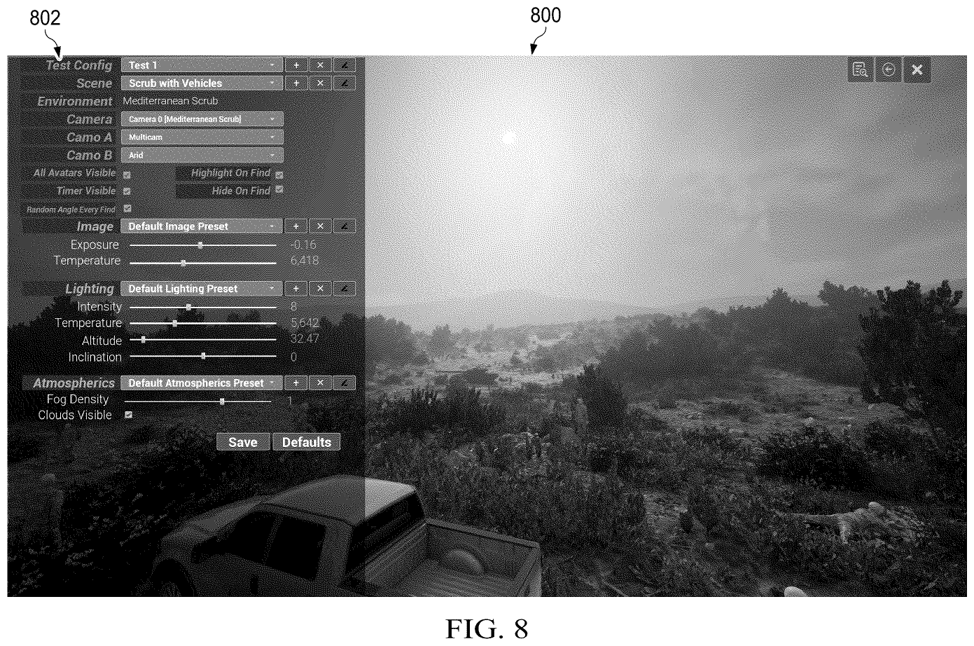

FIG. 8 depicts an example settings window overlay 802 within the environmental scene 800 that allows a user to customize various parameters, e.g., using dropdown menus, sliders, and the like. In some embodiments, the settings may be applied to the environmental scene in real-time, such that the user may view the changes to the environmental scene as a given setting is changed. For example, as the user adjusts sliders for lighting settings, changes in properties such as intensity, temperature, altitude, and inclination may be viewed in real-time, enabling the user to better define a suitable setting in which to evaluate the camouflage design.

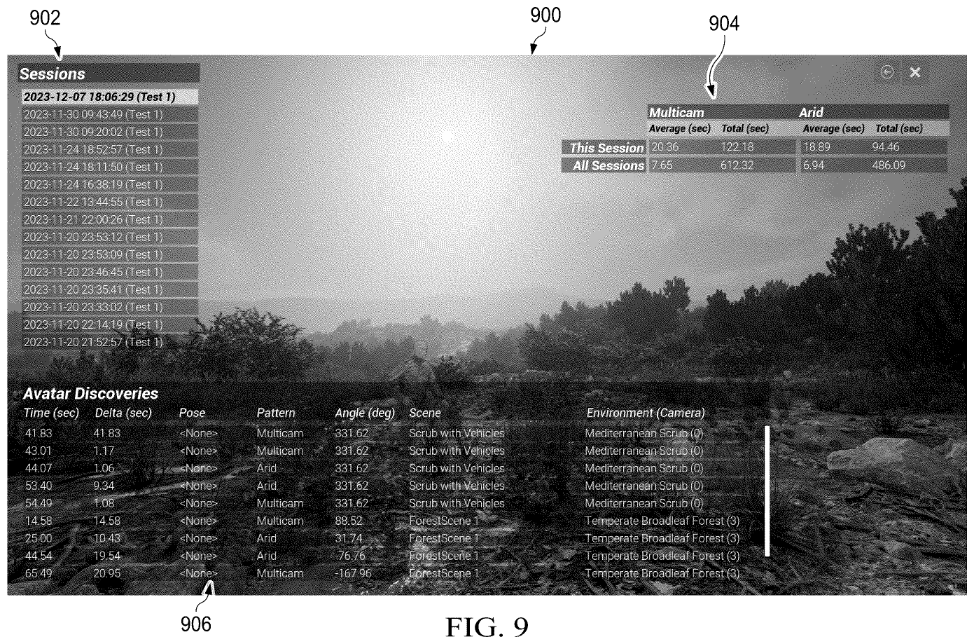

FIG. 9 depicts an example interface 900 that enables the user to view statistics for historical evaluation sessions. As shown, the interface 900 displays, for example, a list of previous sessions 902 indicating the date and time in which a given test was conducted. The example interface 900 also displays a comparison element 904 between a present session relative to an average and running total of previously conducted sessions for the two different designs (here, “multicam” and “arid” designs). Further, the interface 900 also displays a listing 906 of avatar discoveries for the present session, indicating, for example, an amount of time taken to discover a given avatar, a delta indicating an amount of time to identify a subsequent avatar relative to the immediately previous-identified avatar, a pose of the avatar being identified, the camouflage pattern in which the avatar was outfitted, the environmental scene, and the environment. The aforementioned information allows a user to better assess how likely an individual wearing a given camouflage pattern design would be able to blend in or be identified in a given environment.

Articles “a” and “an” are used herein to refer to one or to more than one (i.e. at least one) of the grammatical object of the article. By way of example, “an element” means at least one element and can include more than one element.

“About” is used to provide flexibility to a numerical range endpoint by providing that a given value may be “slightly above” or “slightly below” the endpoint without affecting the desired result.

The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”).

Moreover, the present disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Unless otherwise defined, all technical terms used herein have the same meaning as commonly understood by one of ordinary skill in the art to which this disclosure belongs.

One skilled in the art will readily appreciate that the present disclosure is well adapted to carry out the objects and obtain the ends and advantages mentioned, as well as those inherent therein. The present disclosure described herein are presently representative of preferred embodiments, are exemplary, and are not intended as limitations on the scope of the present disclosure. Changes therein and other uses will occur to those skilled in the art which are encompassed within the spirit of the present disclosure as defined by the scope of the claims.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

We claim:

1. A method comprising:
graphically rendering, by execution of one or more processors, one or more avatars within a 3D photorealistic virtual environment, wherein a first camouflage pattern design is rendered over at least one of the avatars;
generating a prompt for identifying a location of the at least one of the avatars having the first camouflage pattern design rendered;
measuring one or more statistics associated with the identification of the location of the at least one of the avatars; and
generating a score based on the measurement.

2. The method of claim 1, further comprising, receiving one or more changes to parameters of the virtual environment.

3. The method of claim 2, further comprising, rendering the changes in the environment in response.

4. The method of claim 1, wherein the one or more statistics comprises at least an amount of time taken to identify the location of the at least one of the avatars, a delta indicating an amount of time to identify a subsequent location of the at least one of the avatars, or a camera angle from which the user identified the location of the at least one of the avatars.

5. The method of claim 1, further comprising:
generating a report incorporating at least the score; and
outputting the report to a display for review by a second user.

6. The method of claim 1, wherein graphically rendering one or more avatars within a 3D photorealistic virtual environment comprises rendering a first avatar and a second avatar within the virtual environment, wherein the first camouflage pattern design is rendered over the first avatar and wherein another camouflage pattern design is rendered over the second avatar.

7. The method of claim 1, further comprising:
determining whether the score exceeds a specified threshold; and
in response to determining that the score exceeds a specified threshold, causing a printing device to print a fabric incorporating the camouflage pattern design.

8. A system, comprising:
one or more processors; and
a memory storing a plurality of instructions, which, when executed by the one or more processors, cause the system to:
graphically render one or more avatars within a 3D photorealistic virtual environment, wherein a first camouflage pattern design is rendered over at least one of the avatars,
generate a prompt for identifying a location of the at least one of the avatars having the first camouflage pattern design rendered,
measure one or more statistics associated with the identification of the location of the at least one of the avatars, and
generate a score based on the measurement.

9. The system of claim 8, wherein the plurality of instructions further causes the system to receive one or more changes to parameters of the virtual environment.

10. The system of claim 9, wherein the plurality of instructions further causes the system to render the changes in the environment in response.

11. The system of claim 8, wherein the one or more statistics comprises at least an amount of time taken to identify the location of the at least one of the avatars, a delta indicating an amount of time to identify a subsequent location of the at least one of the avatars, or a camera angle from which the user identified the location of the at least one of the avatars.

12. The system of claim 8, wherein the plurality of instructions further causes the system to:
generate a report incorporating at least the score; and
output the report to a display for review by a second user.

13. The system of claim 8, wherein to graphically render one or more avatars within a 3D photorealistic virtual environment comprises to render a first avatar and a second avatar within the virtual environment, wherein the first camouflage pattern design is rendered over the first avatar and wherein another camouflage pattern design is rendered over the second avatar.

14. The system of claim 8, wherein the plurality of instructions further causes the system to:
determine whether the score exceeds a specified threshold; and
in response to a determination that the score exceeds a specified threshold, cause a printing device to print a fabric incorporating the camouflage pattern design.

15. A computer-readable storage medium storing a plurality of instructions, which, when executed on one or more processors, causes a system to:
graphically render one or more avatars within a 3D photorealistic virtual environment, wherein a first camouflage pattern design is rendered over at least one of the avatars;
generate a prompt for identifying a location of the at least one of the avatars having the first camouflage pattern design rendered;
measure one or more statistics associated with the identification of the location of the at least one of the avatars; and
generate a score based on the measurement.

16. The computer-readable storage medium of claim 15, wherein the plurality of instructions further causes the system to receive one or more changes to parameters of the virtual environment, and wherein the plurality of instructions further causes the system to render the changes in the environment in response.

17. The computer-readable storage medium of claim 15, wherein the one or more statistics comprises at least an amount of time taken to identify the location of the at least one of the avatars, a delta indicating an amount of time to identify a subsequent location of the at least one of the avatars, or a camera angle from which the user identified the location of the at least one of the avatars.

18. The computer-readable storage medium of claim 15, wherein the plurality of instructions further causes the system to:
generate a report incorporating at least the score; and
output the report to a display for review by a second user.

19. The computer-readable storage medium of claim 15, wherein to graphically render one or more avatars within a 3D photorealistic virtual environment comprises to render a first avatar and a second avatar within the virtual environment, wherein the first camouflage pattern design is rendered over the first avatar and wherein another camouflage pattern design is rendered over the second avatar.

20. The computer-readable storage medium of claim 15, wherein the plurality of instructions further causes the system to:
determine whether the score exceeds a specified threshold; and
in response to a determination that the score exceeds a specified threshold, cause a printing device to print a fabric incorporating the camouflage pattern design.
